(19) United States
(12) Patent Application Publication
(10) Pub. No.: US 2022/0207647 A1
(43) Pub. Date: Jun. 30, 2022

(54) TRAINING METHOD AND TRAINING SYSTEM FOR RESOLUTION IMPROVEMENT MODEL AND BOUNDARY DETECTION METHOD USING RESOLUTION IMPROVEMENT MODEL

(71) Applicant: INDUSTRIAL TECHNOLOGY RESEARCH INSTITUTE, Hsinchu (TW)

(72) Inventors: Hung-Wei LIN, Taibao City (TW); Sen-Yih CHOU, Hsinchu City (TW); Hsin-Cheng LIN, Hemei Township (TW)

(73) Assignee: INDUSTRIAL TECHNOLOGY RESEARCH INSTITUTE, Hsinchu (TW)

(21) Appl. No.: 17/135,818

(22) Filed: Dec. 28, 2020

(51) Int. Cl. G06T 3/40; G06T 5/00; G06T 5/20; G06T 7/13; G06N 3/08

(52) U.S. Cl. CPC G06T 3/4046; G06T 3/4053; G06T 5/002; G06T 5/003; G06T 5/20; G06N 3/0454; G06N 3/088; G06T 2207/20081; G06T 2207/20192; G06T 2207/20084; G06T 7/13

(57) ABSTRACT

A training method and training system for a resolution improvement model and a boundary detection method using the resolution improvement model are provided. The training method for the resolution improvement model includes the following steps. A low-resolution image is inputted. Pixels of the low-resolution image are captured and reorganized to generate a high-resolution image according to convolutional features. The resolution of the high-resolution image is higher than that of the low-resolution image. When capturing the low-resolution image, a condition mask is used to filter off the noise content, as well as sharpen the edge. The high-resolution image is compared with a ground-truth target image to output a discrimination result. The convolutional features are updated according to the discrimination result.

### TECHNICAL FIELD

The disclosure relates in general to a training method and training system for a resolution improvement model and a boundary detection method using the resolution improvement model.

### BACKGROUND

Over the years, the requirement of boundary detection precision in the fields of image measurement, satellite telemetry, and medical image analysis has increased from 1 pixel to 1/10 to 1/100 pixel. The conventional boundary detection with a precision level of 1 pixel can no longer meet the current requirements of high-precision measurement/detection.

The currently disclosed sub-pixel boundary detection technology includes moment-based estimation, internal and external Interpolations reconstruction or curve fitting. These estimation methods are all based on approximation, and the boundary positions within the pixel are calculated through approximation. Therefore, boundary detection still has problems of uncertainty and errors.

Particularly, in the measurement of line width and space of semiconductor redistribution layer (RDL) and the tumor diagnosis using medical images, if the picture files contain textures, such as colors, intensities and ramp texture, generated during the image capturing process, discontinuous boundary changes at best stage cannot be obtained easily. Under such circumstances, in the application of tumor diagnosis using medical images, doctors may mis-diagnose the position and size of the tumor. In the application of high-precision measurement of line width and space of semiconductor redistribution layer, the accuracy of the position of semiconductor circuit contact and its size will be affected.

### SUMMARY

The disclosure is directed to a training method and training system for a resolution improvement model and a boundary detection method using the resolution improvement model.

According to one embodiment, a training method for a resolution improvement model is provided. The training method for the resolution improvement model includes the following steps. A low-resolution image is inputted. Pixels of the low-resolution image are captured and reorganized to generate a high-resolution image according to convolutional features. The resolution of the high-resolution image is higher than that of the low-resolution image. When capturing the low-resolution image, a condition mask is used to filter off the noise content as well as sharpen the edge. The high-resolution image is compared with a ground-truth target image to output a discrimination result. The convolutional features are updated according to the discrimination result.

According to another embodiment, a boundary detection method using the resolution improvement model is provided. The boundary detection method using the resolution improvement model includes the following steps. A low-resolution image is inputted to a resolution improvement model to obtain a high-resolution image whose noise content has been filtered off and edge has been sharpened. The resolution of the high-resolution image is higher than that of the low-resolution image. The high-resolution image is used for boundary detection.

According to an alternative embodiment, a training system for a resolution improvement model is provided. The training system for the resolution improvement model includes an input unit, a generator and a discriminator. The input unit is configured to input a low-resolution image. The generator is configured to capture and reorganize pixels of the low-resolution image to generate a high-resolution image according to convolutional features. The resolution of the high-resolution image is higher than that of the low-resolution image. When capturing the low-resolution image, a condition mask is used to filter off the noise content, as well as sharpen the edge. The discriminator is configured to compare the high-resolution image with a ground-truth target image to output a discrimination result, and the convolutional features are updated according to the discrimination result.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a boundary detection system using a resolution improvement model according to an embodiment.

FIG. 2 is a flowchart of a boundary detection method using the resolution improvement model according to an embodiment.

FIG. 3 is a schematic diagram illustrating boundary information detected using images with different resolutions.

FIG. 4 is a schematic diagram illustrating the impact of the noise content on the boundary detection.

FIG. 5 is a schematic diagram illustrating the impact of the blurred edges on the boundary detection.

FIG. 6 is a schematic diagram of a training system for a resolution improvement model according to an embodiment.

FIG. 7 is a flowchart of a training method for a resolution improvement model according to an embodiment.

FIG. 8 is a schematic diagram illustrating step S720.

FIG. 9 is a schematic diagram illustrating a multi-task batch processing technology.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

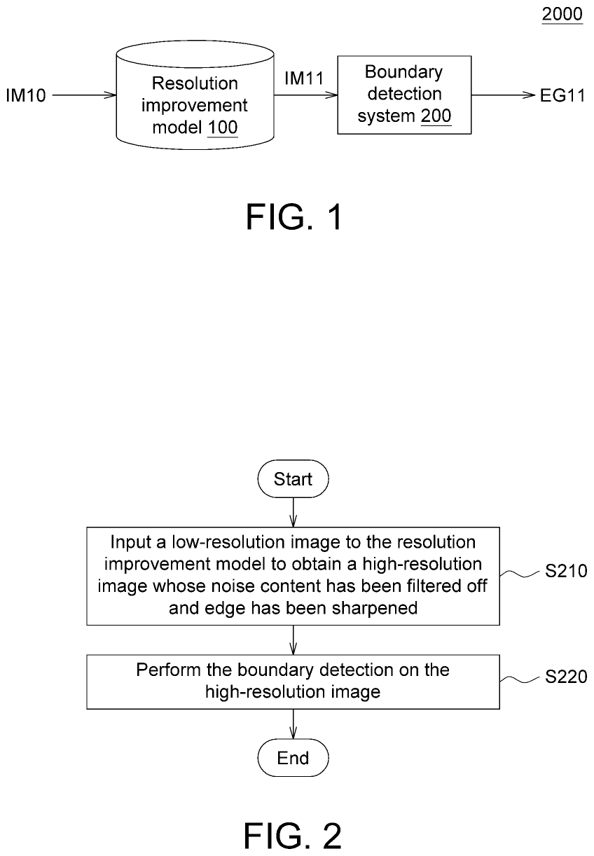

Referring to FIG. 1, a schematic diagram of a boundary detection system 2000 using a resolution improvement model 100 according to an embodiment is shown. The boundary detection system 2000 includes a resolution improvement model 100 and a boundary detection unit 200. The resolution improvement model 100 is used to increase image resolution. The boundary detection unit 200 is configured to perform boundary detection. The resolution improvement model 100 and the boundary detection unit 200 can be realized by a circuit, a chip, a circuit board, several programming codes, or a storage device for storing programming codes. Operation of each of the above element is disclosed below with accompanying drawings.

Referring to FIG. 2, a flowchart of a boundary detection method using the resolution improvement model 100 according to an embodiment is shown. In step S210, a low-resolution image IM10 is inputted to the resolution improvement model 100 to obtain a high-resolution image IM11 whose noise content has been filtered off and edge has been sharpened. The resolution of the low-resolution image IM10 is such as 512*512; the resolution of the high-resolution image IM11 is such as 1024*1024. Next, the method proceeds to step S220, the boundary detection is performed on the high-resolution image IM11 by the boundary detection unit 200 to obtain a boundary information EG11.

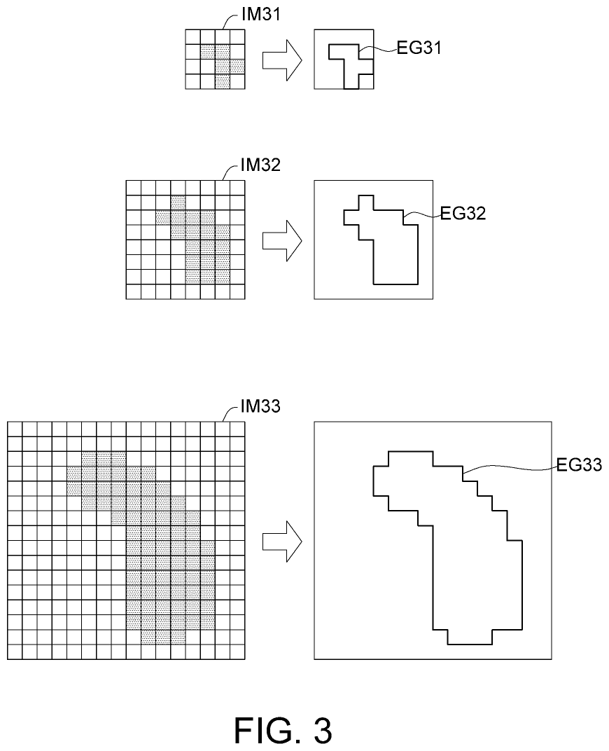

Referring to FIG. 3, a schematic diagram illustrating boundary information EG31, EG32, and EG33 detected using images IM31, IM32, and IM33 with different resolutions is shown. As indicated in FIG. 3, the image IM31 has the lowest resolution, and the image IM33 has the highest resolution. As the resolution increases, the accuracy of the boundary information EG31 increases significantly.

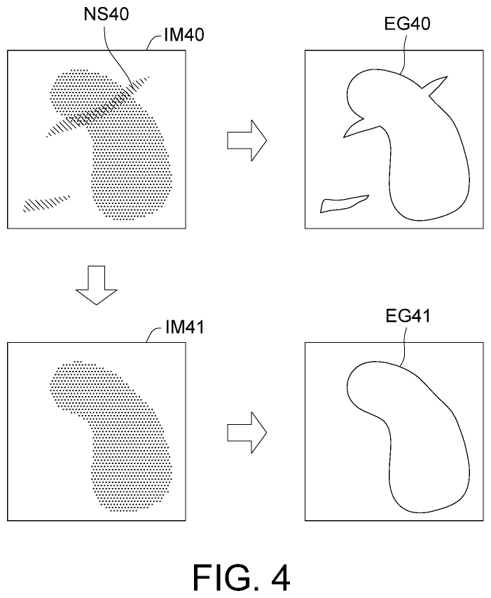

Referring to FIG. 4, a schematic diagram illustrating the impact of a noise content NS40 on the boundary detection is shown. The noise content NS40 is such as scratch or dirt. As indicated in FIG. 4, when the boundary detection is performed on the image IM40 containing the noise content NS40, the noise content NS40 will affect the boundary detection and reduce the accuracy of the boundary information EG40. After the noise content NS40 is filtered off, the noise content NS40 will no longer affect the boundary detection performed on the image IM41, and the accuracy of the boundary information EG41 will be increased.

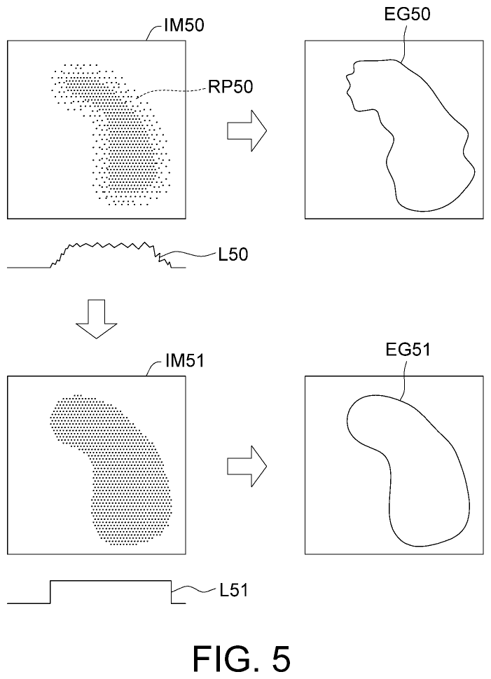

Referring to FIG. 5, a schematic diagram illustrating the impact of blurred edges on the boundary detection is shown. As indicated in FIG. 5, the image IM50 with a ramp texture RP50 has a pixel value curve L50 which changes gradually. When the boundary detection is performed on the image IM50, the ramp texture RP50 will affect the boundary detection and reduce the accuracy of the boundary information EG50. The image IM51 with sharpened edges has a stepped pixel value curve L51. When the boundary detection is performed on the image IM51, the ramp texture RP50 will no longer affect boundary detection, and the accuracy of the boundary information EG51 will be increased.

As indicated in FIG. 1, in the present disclosure, the high-resolution image IM11 has a higher resolution, which significantly increases the accuracy of the boundary information EG11. Since the noise content of the high-resolution image IM11 has been filtered off and the edge has been sharpened, the boundary detection will not be affected by the noise content and the ramp texture.

In the present disclosure, the resolution improvement model 100 plays an important role in the boundary detection process. The resolution improvement model 100 of the present disclosure is a generative adversarial network (GAN) adopting term convolution. The resolution improvement model 100 not only increases the resolution, but further filters off the noise content and sharpens the edge during the resolution increasing process to greatly increase the accuracy of the boundary detection. Detailed descriptions of a training method and a training system for the resolution improvement model 100 are disclosed below.

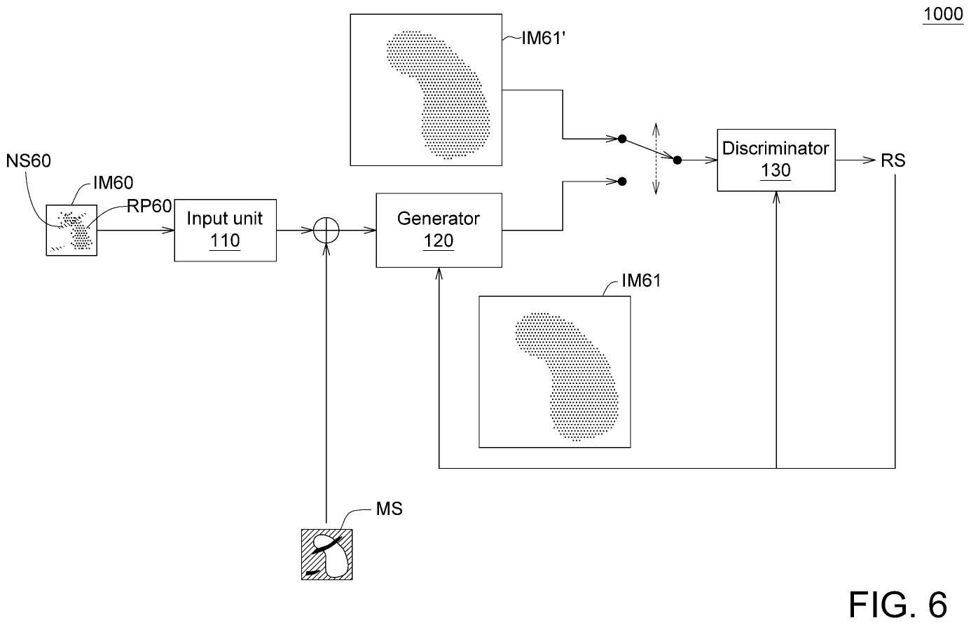

Referring to FIG. 6, a schematic diagram of a training system 1000 for the resolution improvement model 100 according to an embodiment is shown. The training system 1000 includes an input unit 110, a generator 120 and a discriminator 130. Descriptions of each of the above elements are disclosed below. The input unit 110 is configured to input an image. The generator 120 is configured to generate an image. The discriminator 130 is configured to discriminate a generated result. The input unit 110 can be realized by a transmission line, a transmission module or a data reading module. The generator 120 and/or the discriminator 130 can be realized by a circuit, a chip, a circuit board, several programming codes, or a storage device for storing programming codes. The training system 1000 is configured to train the resolution improvement model 100. The resolution improvement model 100 not only increases the resolution, but also further filters off the noise content and sharpens the edge during the resolution increasing process. Operation of each of the above elements is disclosed below with a flowchart.

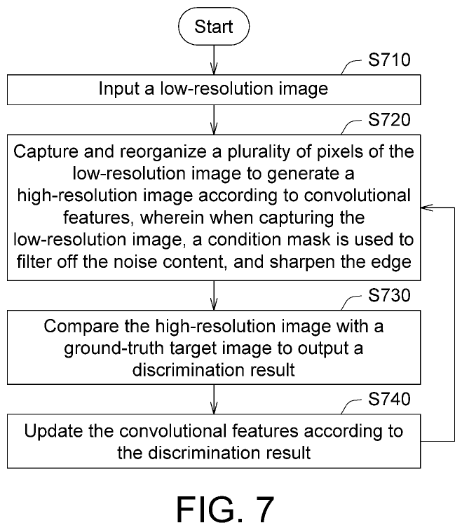

Referring to FIG. 7, a flowchart of a training method for the resolution improvement model 100 according to an embodiment is shown. In step S710, a low-resolution image IM60 is inputted by the input unit 110. The low-resolution image IM60 has a noise content NS60 and a ramp texture RP60. The noise content NS60 is such as scratch or dirt.

Next, the method proceeds to step S720, the low-resolution image IM60 is captured and reorganized by the generator 120 to generate a high-resolution image IM61 according to convolutional features, wherein the resolution of the high-resolution image IM61 is higher than that of the low-resolution image IM60; when the generator 120 captures the low-resolution image IM60, a condition mask MS is used to filter off the noise content, and sharpen the edge. In this embodiment, one physical condition mask is applied both to filter off the noise content and sharpen the edge. Those person has ordinary skill in the art should know that under other suitable conditions, two or more physical conditional may be applied both to filter off the noise content and sharpen the edge.

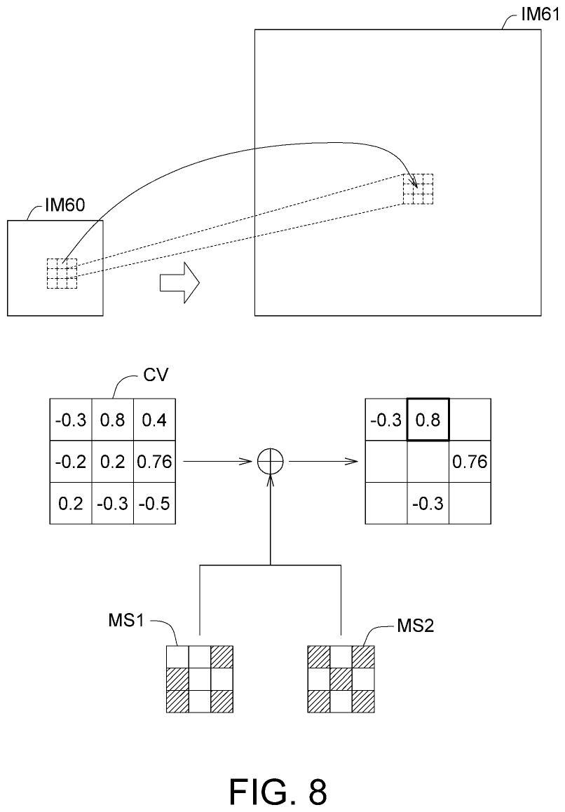

Referring to FIG. 8, a schematic diagram of step S720 is shown. As indicated in FIG. 8, the left-hand side is an N*N low-resolution image IM60, and the right-hand side is a to-be-generated 3N*3N high-resolution image IM61. Each pixel of each convolution layer generates 9 (2^{k}+1) convolutional features where k=3. The condition mask MS is formed of numeric values 0 and 1. The numeric 0 of the condition mask MS corresponds to the noise content NS60, such as a slashed part; the numeric value 1 of the condition mask MS corresponds to the non-noise content, such as a white background. In addition, The condition mask MS is formed of numeric values 0 and 1; the numeric value 0 corresponds to the part of the low-resolution image IM60 whose pixel intensity is lower than a pixel intensity, such as a slashed part; the numeric value 1 corresponds to the part of the low-resolution image IM60 whose pixel intensity is higher than or equivalent to the pixel intensity, such as a white background.

The convolutional features use the condition mask MS to keep only the part corresponding to the numeric value 1 of the condition mask MS. That is, capturing the part corresponding to the numeric value 0 of the first condition mask MS is prohibited.

The numeric values kept in the convolutional features include “−0.3, 0.8, 0.76, −0.3”. Since “0.8” is the largest numeric value, the pixel corresponding to the position of “0.8” is captured from the low-resolution image IM60 to form a pixel of the high-resolution image IM61. By the same analogy, the generator 120 captures pixels from the low-resolution image IM60 and reorganizes the captured pixels to generate the high-resolution image IM61.

That is, when the generator 120 generates the high-resolution image IM61, the generator 120 uses the condition mask MS to weaken the noise content NS60 and to enforce the edge as well.

Then, the method proceeds to step S730, as indicated in FIG. 6, the high-resolution image IM61 is compared with a ground-truth target image IM61′ by the discriminator 130 to output a discrimination result RS. For example, the discriminator 130 can obtain the discrimination result RS according to a peak signal-to-noise ratio (PSNR) to confirm whether the high-resolution image IM61 is similar to the ground-truth target image IM61′.

Then, the generator 120 updates the convolutional features according to the discrimination result RS, such that the high-resolution image IM61 generated next time can be closer to the ground-truth target image IM61′. Steps S720 to S740 are repeatedly performed to continuously optimize the output.

According to the above embodiments, the resolution improvement model 100 trained by the training system 1000 not only increases the resolution, but also further filters off the noise content and sharpens the edge during the resolution increasing process. The high-resolution image IM61 has a higher resolution and significantly increases the accuracy of boundary detection. Besides, since the noise content of the high-resolution image IM61 have been filtered off and the edge has been sharpened, the boundary detection will not be affected by noise content and ramp texture.

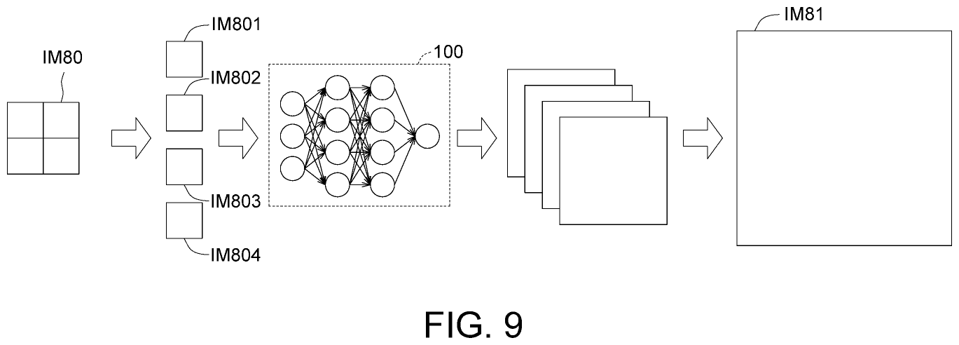

Moreover, in steps S710 to S740 of the boundary detection method, the boundary detection speed is optimized using a multi-task batch processing technology. Referring to FIG. 9, a schematic diagram illustrating the multi-task batch processing technology is shown. In step S720, the low-resolution image IM80 can be divided into several low-resolution sub-images IM801 to IM804. The low-resolution image IM80 has a resolution of 512*512, and the low-resolution sub-images IM801 to IM804 have a resolution of 128*128. The low-resolution sub-images IM801 to IM804 are inputted to the resolution improvement model 100 and are processed using a parallel processing technology to obtain a high-resolution image IM81. The multi-task batch processing technology can optimize the processing speed of step S720, such that the processing speed of the boundary detection method can be effectively optimized.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A training method for a resolution improvement model, comprising:
inputting a low-resolution image;
capturing and reorganizing a plurality of pixels of the low-resolution image to generate a high-resolution image according to convolutional features, wherein resolution of the high-resolution image is higher than that of the low-resolution image, and when capturing the low-resolution image, a condition mask is used to filter off a noise content, and sharpen an edge;
comparing the high-resolution image with a ground-truth target image to output a discrimination result;
updating the convolutional features according to the discrimination result.

2. The training method for the resolution improvement model according to claim 1, wherein the condition mask is formed of numeric values 0 and 1, and the numeric value 0 corresponds to the noise content.

3. The training method for the resolution improvement model according to claim 2, wherein in the step of capturing and reorganizing the plurality of pixels of the low-resolution image to generate the high-resolution image according to the convolutional features, capturing the pixels corresponding to the condition mask with the numeric value 0 is prohibited.

4. The training method for the resolution improvement model according to claim 2, wherein the noise content is scratch or dirt.

5. The training method for the resolution improvement model according to claim 1, wherein condition mask is formed of numeric values 0 and 1, the numeric value 0 corresponds to part of the low-resolution image lower than a pixel intensity, and the numeric value 1 corresponds to part of the low-resolution image higher than or equivalent to the pixel intensity.

6. The training method for the resolution improvement model according to claim 5, wherein in the step of capturing and reorganizing the plurality of pixels of the low-resolution image to generate the high-resolution image according to the convolutional features, capturing the pixels corresponding to the condition mask with the numeric value 0 is prohibited.

7. The training method for the resolution improvement model according to claim 1, wherein in the step of comparing the high-resolution image with the ground-truth target image to output the discrimination result, the discrimination result is obtained according to a peak signal-to-noise ratio (PSNR).

8. The training method for the resolution improvement model according to claim 1, wherein the resolution improvement model is a generative adversarial network (GAN).

9. A boundary detection method using a resolution improvement model, comprising:
inputting a low-resolution image to a resolution improvement model to obtain a high-resolution image whose noise content has been filtered off and edge has been sharpened, wherein resolution of the high-resolution image is higher than that of the low-resolution image; and
performing a boundary detection using the high-resolution image.

10. The boundary detection method using the resolution improvement model according to claim 9, wherein the resolution improvement model is a generative adversarial network (GAN).

11. The boundary detection method using the resolution improvement model according to claim 9, wherein the resolution improvement model is trained using a condition mask, the condition mask is used to filter off the noise content, as well as sharpen the edge.

12. A training system fora resolution improvement model, comprising:
an input unit configured to input a low-resolution image;
a generator configured to capture and reorganize a plurality of pixels of the low-resolution image to generate a high-resolution image according to convolutional features, wherein resolution of the high-resolution image is higher than that of the low-resolution image, and when capturing the low-resolution image, a condition mask is used to filter off a noise content, and sharpen an edge; and
a discriminator configured to compare the high-resolution image with a ground-truth target image to output a discrimination result, such that the convolutional features are updated according to the discrimination result.

13. The training system for the resolution improvement model according to claim 12, wherein condition mask is formed of numeric values 0 and 1, and the numeric value 0 corresponds to the noise content.

14. The training system for the resolution improvement model according to claim 13, wherein the generator is prohibited to capture the pixels corresponding to the condition mask with the numeric value 0.

15. The training system for the resolution improvement model according to claim 13, wherein the noise content is scratch or dirt.

16. The training system for the resolution improvement model according to claim 11, wherein the condition mask, is formed of numeric values 0 and 1, the numeric value 0 corresponds to part of the low-resolution image lower than a pixel intensity, and the numeric value 1 corresponds to part of the low-resolution image higher than or equivalent to the pixel Intensity.

17. The training system for the resolution improvement model according to claim 16, wherein the generator is prohibited to capture the pixels corresponding to the condition mask with the numeric value 0.

18. The training system for the resolution improvement model according to claim 12, wherein the discriminator obtains the discrimination result according to a peak signal-to-noise ratio (PSNR).

19. The training system for the resolution improvement model according to claim 12, wherein the resolution improvement model is a generative adversarial network (GAN).
